(19) United States
(12) Patent Application Publication
(10) Pub. No.: US 2011/0303357 A1
(43) Pub. Date: Dec. 15, 2011

(54) PROCEDURE FOR THE MANUFACTURE OF LARGE PARTS OF COMPOSITE MATERIAL CONTROLLING THE THICKNESS OF THE EDGES THEREOF

(75) Inventors: Teresa Latorre Plaza, Madrid (ES); José Gregorio Iniesta Menéndez, Getafe (ES); Josep Morancho Rodriguez, Valdemoro (ES); José Manuel Menéndez Martin, Boadilla del Monte (ES)

(73) Assignee: AIRBUS OPERATIONS S.L., Getafe (ES)

(21) Appl. No.: 13/110,076

(22) Filed: May 18, 2011

(30) Foreign Application Priority Data
Jun. 10, 2010 (ES) 201030897

(51) Int. Cl. B32B 37/14; B32B 37/12; B32B 38/00; B32B 37/02

(52) U.S. Cl. 156/281

(57) ABSTRACT

Procedure for the manufacture of large parts of composite material, controlling the thickness of the edges thereof. It relates to the manufacture of a part (11) possessing edge zone (11) in an aeronautical structure through a join with joining plate (23) and backing plate (25) by means of the following stages: a) Definition of interface surface (15) of edge zone (13) to be in contact with joining plate (23); b) Manufacture of first panel (31) possessing the configuration planned for part (11); c) Obtainment of a map of differences between the thickness of first panel (31) and that which it should possess to be coincident with said interface surface (15); d) Manufacture of supplementary panel (33) having a thickness to be coincident with that of said map of differences; e) joining of supplementary panel (33) to first panel (31).

### FIELD OF THE INVENTION

The present invention relates to a procedure for the manufacture of large parts of composite material, controlling the thickness of the edges thereof joined to other parts, and more particularly to a procedure for the manufacture of the skin of a wing of an aircraft, controlling the thickness of the edge thereof joined to a central box by means of an intermediate plate.

### BACKGROUND OF THE INVENTION

As is well known the aeronautical industry requires structures which on the one hand withstand the loads to which they are subject, complying with stringent requirements of strength and rigidity, and on the other are as light as possible. One consequence thereof is the increasingly widespread use of composite materials, particularly CFRP (carbon-fibre reinforced plastic) in primary structures by virtue of the large saving in weight achievable in comparison with metal materials.

### SUMMARY OF THE INVENTION

Following this tendency there are known, for example, lifting surfaces of aircraft consisting in two torsion boxes (on the left and right sides) joined to a central box integrally realised with CFRP panels utilising as skins for said boxes unit parts, that is to say, utilising four complete skins (two upper and two lower skins) to manufacture such left and right torsion boxes. As may be clearly understood, incorporation of this type of part creates diverse problems flowing from the large size and complexity of the geometry thereof.

One of such problems is controlling the thickness of those zones of the parts joined to others by means of intermediate joining plates.

The solution to this problem when metal materials were utilised was to machine the affected zones to achieve appropriate thicknesses. The same approach is applicable to parts of composite materials adding, as appropriate, sacrificial fabric plies, however the cost thereof is very high.

The present invention is directed at the solution of this problem.

One object of the present invention is the provision of a procedure, optimised in terms of costs, for manufacture of parts of composite material of large size permitting controlling the thickness of the edges thereof joined to other parts.

A further object of the present invention is the provision of a procedure, optimised in terms of costs, for manufacture of lower skins of aircraft wings of composite material permitting controlling the thickness of the edge thereof joined to a central box by means of an intermediate joining part.

These and other objects are achieved through a procedure for the manufacture of a part of composite material incorporated into an aeronautical structure by disposing a join comprising a joining plate and a backing plate between which is located an edge zone of said part, comprising the following stages:

a) Definition of the interface surface which the edge zone of the part must possess to be in contact with the joining plate in said joint disposition.

b) Manufacture of a first panel possessing the configuration planned for the entire extent of the part.

c) Obtainment of a map of differences between the thickness of such first panel and the thickness which it should possess in the zone in contact with the joining plate such that its upper surface is coincident with said interface surface.

d) Manufacture of a supplementary panel for said edge zone with composite material such as to possess a thickness coincident with that of said map of differences.

e) Such supplementary panel is joined to the first panel.

In a preferential embodiment the composite material utilised for manufacture of said first panel is CFRP and the composite material utilised for manufacture of said supplementary panel is a sacrificial material. Thereby a procedure is achieved for manufacture of parts of composite material of large size permitting controlling the thickness of the edges thereof joined to other parts whereby the cost of the material utilised is optimised.

In another preferential embodiment manufacture of the supplementary panel includes a phase of machining on a planar surface such that at every point it possesses the required thickness. Thereby it is achieved that the machining operation, a costly operation, is applied solely to the supplementary panel having dimensions much smaller than those of the first panel.

In a further preferential embodiment the join between the supplementary panel and the first panel is realised by means of a process of secondary adhesive bonding. Thereby a procedure is achieved for manufacture of parts of composite material of large size permitting controlling the thickness of the edges thereof joined to other parts, facilitating industrialisation thereof.

In yet another preferential embodiment the joining plate is realised in a metal material and stage d) includes incorporation of a layer of composite material with glass fibre on the surface of the supplementary panel destined to remain in contact with said joining plate. Thereby a procedure is achieved for manufacture of parts of composite material of large size permitting simple incorporation of a layer of glass fibre to prevent corrosion.

In yet a further preferential embodiment said aeronautical structure is an aircraft wing, said part is the lower skin of the wing and said joining plate is a joining plate to a central box of the fuselage of a the aircraft. Thereby an efficacious procedure is achieved for manufacture of aircraft wings with composite materials.

Other characteristics and advantages of the present invention will be inferred from the following detailed description of an illustrative embodiment of the object thereof in relation to the figures accompanying it.

### DESCRIPTION OF THE FIGURES

FIG. 1 is a schematic view of a known disposition of join of the lower skins of the wing of an aircraft to a central box.

FIG. 2 is a partial schematic view of a disposition of join of a lower skin of the wing of an aircraft manufactured according to the procedure object of the present invention to the central box by means of an intermediate T-shaped plate.

FIG. 3 is a perspective view of the two panels utilised for manufacturing a lower skin of the wing of an aircraft according to the procedure object of the present invention and of said intermediate T-shaped plate.

### DETAILED DESCRIPTION OF THE INVENTION

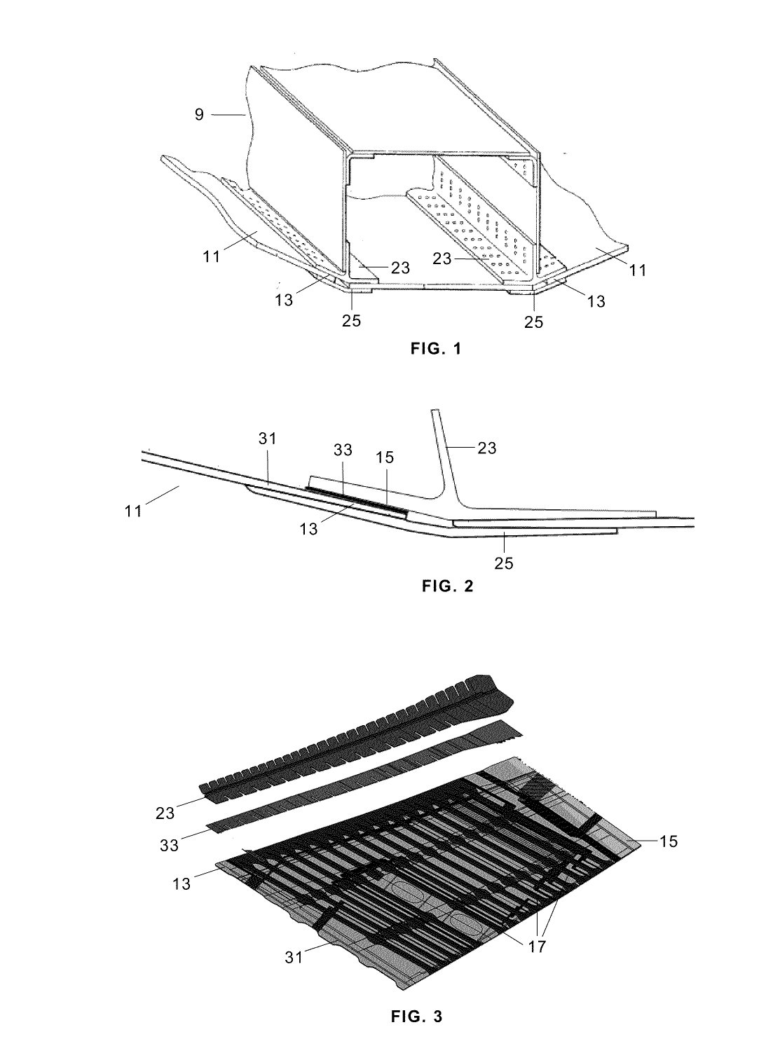

FIG. 1 illustrates a known structure of a wing of an aircraft wherein lower skins 11 of the wing are joined to central box 9 of the fuselage of the aircraft by dispositions of joint comprising T-shaped joining plates 23, known as triform plates, and backing plates 25. Both lower skins 11 of the wing and panels or central box 9 are realised with composite materials, particularly CFRP (carbon-fibre reinforced plastic). Joining plates 23 and backing plates 25 are habitually realised with a metal material although they could also be realised with composite materials.

As may be observed in FIG. 1 joining edge 13 of skin 11 to joining plate 23 and to backing plate 25 must possess very precise geometry such that the mechanical join to joining plate 23 and to backing plate 25 be efficacious, implying that if it is desired to facilitate the erection of the assembly of the wing of the aircraft, skin 11 must reach the erection line possessing its joining edge 13 duly configured to comply with the established required tolerances.

To achieve this objective the procedure object of the present invention comprises the following stages (see FIGS. 2 and 3):

a) Definition of interface surface 15 which joining edge 13 of skin 11 must possess to be in contact with joining plate 23 in said joint disposition. Such interface surface 15 is consequently a surface substantially coincident with the lower surface of joining plate 23.

b) Manufacture of a first panel 31 possessing the configuration planned for the entire extent of skin 11, that is to say without taking into account the specific requirements of joining edge 13 thereof. As may be observed in FIG. 3 such panel 31 is formed by skin 15 and a plurality of stiffening elements 17. Such manufacture is realised utilising any method known in the art of manufacture of panels of composite materials such as a method having a first stage of taping skin 15 of panel 31 with preimpregnated material utilising an ATL machine on a mould possessing the shape of the external surface of the skin, on the one hand, and of conformation of rigidity elements 17, on the other, and a second stage of curing the assembly of panel 31 in an autoclave.

c) Obtainment of a map of differences between the thickness of said first panel 31 and the thickness which it should possess in order that the upper surface thereof is coincident with said interface surface 15 on joining edge 13. The surface to be controlled is measured by a laser interferometer scanner, in this manner achieving digitalisation of the relief in addition to the relative position with respect to the theoretical model.

d) Manufacture of supplementary panel 33 (represented having an exaggerated thickness in FIG. 2 to facilitate appreciation thereof) for said edge zone 13 in conformity with a theoretical model obtained from the results obtained in the foregoing stage, utilising a computer-aided design program therefore. A sacrificial composite material is used (understanding thereby a composite material which, without having a strictly strength function, is a material suitable to be joined to first panel 31) which, subsequent to the corresponding curing stage, is machined on a planar surface. Supplementary panel 33 will thus possess a thickness at every point coincident with that required to attain the theoretical position of interface surface 15.

Should joining plate 23 be metal a first glass-fibre fabric ply is included on the base of supplementary panel 33, forming the surface in contact with joining plate 23 and preventing corrosion between both surfaces.

e) Supplementary panel 33 is joined to first panel 31 utilising adhesive material.

One advantage of the present invention is of providing a procedure of manufacture of the lower skin of the wing of an aircraft facilitating the industrialisation thereof by virtue of saving in the time of an edging machine and footprint. Such supplementary panels are manufactured in an independent centre utilising a device having dimensions much smaller than those of the edging machine, by virtue of the fact that the latter is required to encompass the surface of the entire part.

A further advantage of the present invention is of permitting direct incorporation of the aforementioned glass-fibre fabric ply, should metal joining plates 23 be used, to prevent corrosion in a very simple manner and without requiring adding a supplementary operation following conventional machining of the surface.

Those modifications comprised within the scope defined by the following claims may be introduced into the aforedescribed preferential embodiment.

1. A procedure for manufacture of a part (11) of composite material incorporated into an aeronautical structure by means of a joint disposition comprising joining plate (23) and backing plate (25) between which is located edge zone (13) of said part (11), characterised in that it comprises the following stages:
a) definition of interface surface (15) which edge zone (13) of part (11) must possess to be in contact with joining plate (23) in said joint disposition;
b) manufacture of first panel (31) possessing the configuration planned for the entire extent of part (11);
c) obtainment of a map of differences between the thickness of first panel (31) and the thickness which it should possess in edge zone (13) in contact with joining plate (23) such that the upper surface thereof is coincident with said interface surface (15);
d) manufacture of supplementary panel (33) for said edge zone (13) such that it possesses a thickness coincident with that of said map of differences;
e) supplementary panel (33) is joined to first panel (31).

2. A procedure for manufacture of a part (11) of composite material according to claim 1, characterised in that the composite material utilised for manufacture of said first panel (31) is CFRP and in that the material utilised for manufacture of said supplementary panel (33) is a sacrificial composite material.

3. A procedure for manufacture of a part (11) of composite material according to claim 2, characterised in that stage d) includes a machining phase on a planar surface.

4. A procedure for manufacture of a part (11) of composite material according to claim 1, characterised in that stage e) is realised through a process of secondary adhesive bonding.

5. A procedure for manufacture of a part (11) of composite material according to claim 1, characterised in that said joining plate (23) is realised with a metal material and in that stage d) includes incorporation of a layer of composite material with glass fibre on the surface of supplementary panel (33) destined to remain in contact with said joining plate (23).

6. A procedure for manufacture of a part (11) of composite material according to claim 1, characterised in that said aeronautical structure is a wing of an aircraft, said part (11) is the lower skin of the wing and said joining plate (23) is a joining plate to central box (9) of the fuselage of the aircraft.
